(19) United States
(12) Patent Application Publication
(10) Pub. No.: US 2012/0066672 A1
(43) Pub. Date: Mar. 15, 2012

(54) Systems and Methods for Implementing Upgradeable Subscriber-Controlled Managed Package Components in a Multi-Tenant Environment

(75) Inventors: Andrew Smith, San Francisco, CA (US); Danil Dvinov, San Francisco, CA (US); Timothy P. Kral, San Francisco, CA (US)

(73) Assignee: salesforce.com, inc., San Francisco, CA (US)

(21) Appl. No.: 13/048,516

(22) Filed: Mar. 15, 2011

Related U.S. Application Data
(60) Provisional application No. 61/314,539, filed on Mar. 16, 2010.

(51) Int. Cl. G06F 9/44

(52) U.S. Cl. 717/170; 717/168

(57) ABSTRACT

Systems and methods for installing and upgrading application packages to an application platform include mechanisms for allowing subscribers to make changes to components contained in managed installed packages, while allowing for upgrades of such components. The mechanisms give the subscriber the choice of using developer provided components (the ones that belong to the original package), or creating their own. This also allows developers to package the components, knowing that subscribers won't be limited to using only what's packaged, but rather will be able to make changes if they wish. Information about multiple versions of the same installed managed component is stored and managed with different ownership (e.g., one version belongs to a developer, the other to the subscriber) while in the context of a subscriber organization.

### CROSS-REFERENCE TO RELATED APPLICATIONS

This application claims the benefit of U.S. Provisional Application No. 61/314,539, filed Mar. 16, 2010, which is incorporated by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention generally relates to sharing and accessing data, and more particularly to enabling upgradeable package components in an on-demand database and/or application service.

The concept of having an upgradeable subscriber-controlled managed package component has not been in existence. Upgradeable managed components have always been developer controlled, meaning once the subscriber installs a package, they can not change anything about components they install. To emulate an upgradeable behavior, the developer would not package certain components, but would advise the subscriber on how to create the components on their own. Upon the installation of a newer package version, the developer would have to work with the subscriber yet again if components were changed. Such an approach makes the developer's package less usable out of the box, and creates and additional burden on both the developer and the subscriber.

For example, standard action overrides on a custom object are not packageable. If a developer is using a visualforce page for the detail page of one of their objects, a subscriber must install the package and then manually remap to standard actions overrides to the various visualforce pages. This creates an extremely cumbersome trial experience for subscribers when downloading an application, e.g., off the AppExchange.

Accordingly, it is desirable to provide systems and methods that overcome or at least partially alleviate the above problems.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF SUMMARY

Embodiments of the present invention provide techniques for allowing subscribers to make changes to components contained in managed installed packages, while allowing for upgrades of such components.

According to an embodiment, a method for upgrading application packages installed in a multi-tenant database system, includes receiving from a developer an application package having at least one developer provided component (original component) that is upgradeable, storing the at least one original component in a relational database table according to component type, receiving an upgraded component for the original component from the developer, and replacing the at least one original component stored in the relational database with the upgraded component. Upon determining that the at least one original component is being used by a subscriber and not overridden with a second component, the application package uses the upgraded component instead of the at least one original component. The application package can include more than the original component that is upgradeable by the developer. The second component that overrides the at least one original component can be generated by the subscriber. The developer provided component (original component) can be the original component that belongs to the original package.

According to another embodiment, the method further includes storing a developer row in a table, and, upon determining that the at least one original component has been overridden with the second component, storing a subscriber row in the table. The developer row can include a first indicator indicating that the at least one original component has been upgraded. The subscriber row can include a second indicator indicating that the subscriber is using the second component. The method can further include determining that the at least one original component is being used by the subscriber, and not overridden, if the subscriber row has not been stored in the table. The method can also further include determining that the at least one original component is not used if the subscriber row has been stored in the table. Upon determining that the at least one original component is not being used, continuing to use the second component instead of the upgraded component.

According to yet another embodiment, using the upgraded component instead of the at least one original component includes automatically using the upgraded component.

According to another embodiment, a method for upgrading application packages installed in a multi-tenant database system includes storing an application package having at least one original component that is upgradeable, generating multiple versions of the at least one original component, storing information about the multiple versions of the at least one original component, receiving an upgraded component for the at least one original component from the application package developer, manipulating the information about the multiple versions of the same stored managed component based on whether the at least one original component is being used by a subscriber and not overridden with a second component. Each version of the at least one original component can have a different ownership. Storing and manipulating can be done in the context of the subscriber organization. The application package can include more than the original component that is upgradeable by the developer.

According to another embodiment, storing information further includes storing a developer row in a table, and manipulating the information further includes storing a subscriber row in the table if the subscriber is using the second component instead of the at least one original component. The developer row can include a first indicator indicating that the at least one original component has been upgraded. The subscriber row can also include a second indicator indicating that the subscriber is using the second component. The method can further include determining that the at least one original component is being used and not overridden if the subscriber row has not been stored in the table. The method can also further include determining that the at least one original component is not being used if the subscriber row has been stored in the table. Upon determining that the at least one original component is not being used, continuing to use the second component instead of the upgraded component.

According to yet another embodiment, upon determining that the at least one original component is being used and not overridden, the method uses the upgraded component instead of the at least one original component. Using the upgraded component instead of the at least one original component can include automatically using the upgraded component.

According to another embodiment, a computer-readable medium stores computer code for controlling one or more processor components to manage upgrading application packages installed in a multi-tenant database system. The application package includes at least one original component that is upgradeable by the developer. The code includes instructions to receive an application package from a developer, store the at least one original component in a relational database table according to component type, receive an upgraded component for the original component from the developer, and replace the at least one original component stored in the relational database with an upgraded component. Upon determining that the at least one original component is being used by a subscriber and not overridden with a second component, use the upgraded component instead of the at least one original component. The second component that overrides the at least one original component can be generated by the subscriber.

According to yet another embodiment, the code further includes instructions to store a developer row in a table, and upon determining that the at least one original component has been overridden with the second component, stores a subscriber row in the table. The developer row can include a first indicator indicating that the at least one original component has been upgraded. The subscriber row can include a second indicator indicating that the subscriber is using the second component. The code can include instructions to determine that the at least one original component is being used and not overridden if the subscriber row has not been stored in the table. The code can also include instructions to determine that the at least one original component is not being used if the subscriber row has been stored in the table, and upon determining that the at least one original component is not being used, continues to use the second component instead of the upgraded component.

According to yet another embodiment, the computer code includes instructions to automatically use the upgraded component.

According to another embodiment, a computer-readable medium stores computer code for controlling one or more processor components to manage upgrading application packages installed in a multi-tenant database system. The application package includes at least one original component that is upgradeable by the developer. The code includes instructions store an application package from a developer, generate multiple versions of the at least one original component, store information about the multiple versions of the at least one original component, each version having a different ownership, receive an upgraded component for the original component from the developer, and manipulate the information about the multiple versions of the same stored managed component based on whether the at least one original component is being used by a subscriber and not overridden with a second component. The instructions to store and manipulate can be done in the context of the subscriber organization.

According to another embodiment, the instructions to store information further include instructions to store a developer row in a table and the instructions to manipulate the information further includes instructions to store a subscriber row in the table if the subscriber uses a second component instead of the at least one original component. The developer row can include a first indicator indicating that the at least one original component has been upgraded. The subscriber row can include a second indicator indicating that the subscriber is using the second component. The code can further include instructions to determine that the at least one original component is being used and not overridden if the subscriber row has not been stored in the table. The code can also further include instructions to determine that the at least one original component is not being used if the subscriber row has been stored in the table. Upon determining that the at least one original component is not being used, continue to use the second component instead of the upgraded component.

According to yet another embodiment, the code of the computer-readable medium further includes instructions to use the upgraded component instead of the at least one original component upon determining that the at least one original component is being used and not overridden. The instructions to use the upgraded component instead of the at least one original component can include instructions to automatically use the upgraded component.

According to another embodiment, a system manages installation and upgrades of application packages installed to a multi-tenant database system. The system includes a database system for storing components of the application package according to component type, and one or more processors. The one or more processors are configured to receive the application package from a developer that has at least one original component that is upgradeable by the developer, store the at least one original component in the database table according to component type, and replace the at least one original component stored in the relational database with the upgraded component for the original component in response to receiving from the developer an upgraded component. Upon determining that the at least one original component is being used by a subscriber and not overridden with a second component, use the upgraded component instead of the at least one original component.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of the invention may be realized by reference to the remaining portions of the specification and the drawings, presented below. The Figures are incorporated into the detailed description portion of the invention. Like reference numerals refer to the same items throughout the Figures.

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

FIG. 3A is a flowchart illustrating a method of upgrading an application package installed in a multi-tenant database system, according to one embodiment.

FIG. 3B is a flowchart illustrating how to determine which component to use at the runtime of the application (subscriber's variation or developer's variation), according to one embodiment.

FIG. 4 illustrates a user interface (UI) page in the developer organization according to one embodiment.

FIG. 5 illustrates a UI page in the subscriber organization according to one embodiment.

FIG. 6 illustrates a UI page in a multi-tenant database system according to one embodiment.

FIG. 7 illustrates a UI page, as it appears in the developer organization, according to one embodiment.

FIG. 8 illustrates a UI page that opens when the developer selects an Edit action, as it appears in the developer organization, according to one embodiment.

FIG. 9 illustrates a UI page after the developer has overridden the “Edit” action illustrated in FIG. 8, as it appears in the developer organization, according to one embodiment.

FIG. 10 illustrates a UI page after a subscriber uploads and installs a developer's package, as it appears in the subscriber organization, according to one embodiment.

FIG. 11 illustrates a UI page that opens when the subscriber selects an Edit action for a Label/Name, which was not previously upgraded by a developer, as it appears in the subscriber organization, according to one embodiment.

FIG. 12 illustrates a UI page after the subscriber has overridden the “View” Label/Name, as it appears in the subscriber organization, according to one embodiment.

FIG. 13 illustrates a UI page that opens when the subscriber selects an Edit action for a Label/Name, which was previously upgraded by a developer, as it appears in the subscriber organization, according to one embodiment.

FIG. 14 illustrates a UI page after the subscriber has overridden the “Edit” Label/Name, which was previously upgraded by a developer, as it appears in the subscriber organization, according to one embodiment.

FIG. 15 illustrates a UI page after the subscriber organization has overridden the “Edit” Label/Name settings from “My Scontrol (Visualforce Page),” which was previously set by the developer organization, to the “Standard Salesforce Page” setting, as it appears in the subscriber organization, according to one embodiment.

### DETAILED DESCRIPTION

The present invention provides systems and methods for enabling upgradeable subscriber-controlled managed package components in an on-demand database and/or application service.

Embodiments provide methods and mechanisms for allowing subscribers to make changes to components contained in managed installed packages, while allowing for upgrades of such components. This advantageously makes packaging more flexible by giving the subscriber the choice of using developer provided components (the ones that belong to the original package), or creating their own. This also allows developers to package the components, knowing that subscribers won't be limited to using only what's packaged, but rather will be able to make changes if they wish. In certain aspects, information about multiple versions of the same installed managed component is stored and managed with different ownership (e.g., one version belongs to a developer, the other to the subscriber) while in the context of a subscriber organization.

Embodiments further allow for packaging of standard action overrides on custom objects, which is different than the standard developer-controlled vs. subscriber-controlled approaches used. In one embodiment, a layering approach is used allowing both the developer and subscriber to maintain values for the same attribute independently. According to embodiments, a developer maintains a setting while a subscriber can freely override the developer's setting. The developer's setting can be upgraded; however, a subscriber supplied override will apply at runtime. In the event the subscriber no longer wants to use their override, they can revert to the developer provided setting. According to embodiments, the subscriber cannot delete or change the developer provided setting. According to other embodiments, the subscriber can also override the developer setting with the standard host system UI. In essence, a developer provided setting is analogous to the host system providing a standard UI. A subscriber can freely override this UI and thus a subscriber to a partner's application should be able to freely override a partner's UI. The option to use the standard host system UI will only appear for the subscriber when the action has a developer provided setting. Otherwise, the option will not be available. If in an upgrade, the developer removes their override (reverting to the standard host system UI), the subscriber supplied setting is maintained even if it is the standard host system UI. That way if the developer later adds back a setting, the subscriber's UI will not change on upgrade. An example of the standard host system UI is a “standard salesforce.com UI.”

As used herein, the term multi-tenant database system refers to those systems in which various elements of hardware and software of the database system may be shared by one or more customers. For example, a given application server (e.g. running an application process) may simultaneously process requests for a great number of customers, and a given database table may store rows for a potentially much greater number of customers. As used herein, the term query or query plan refers to a set of steps used to access information in a database system.

### System Overview

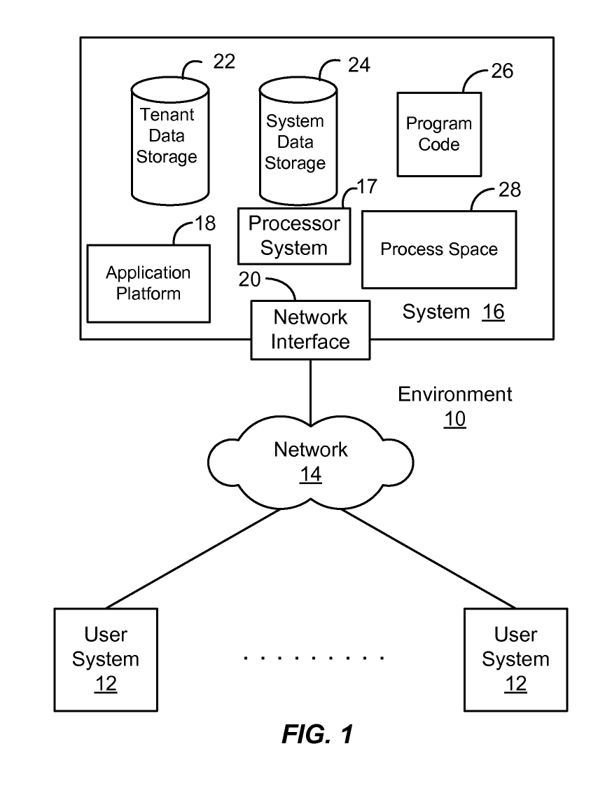

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

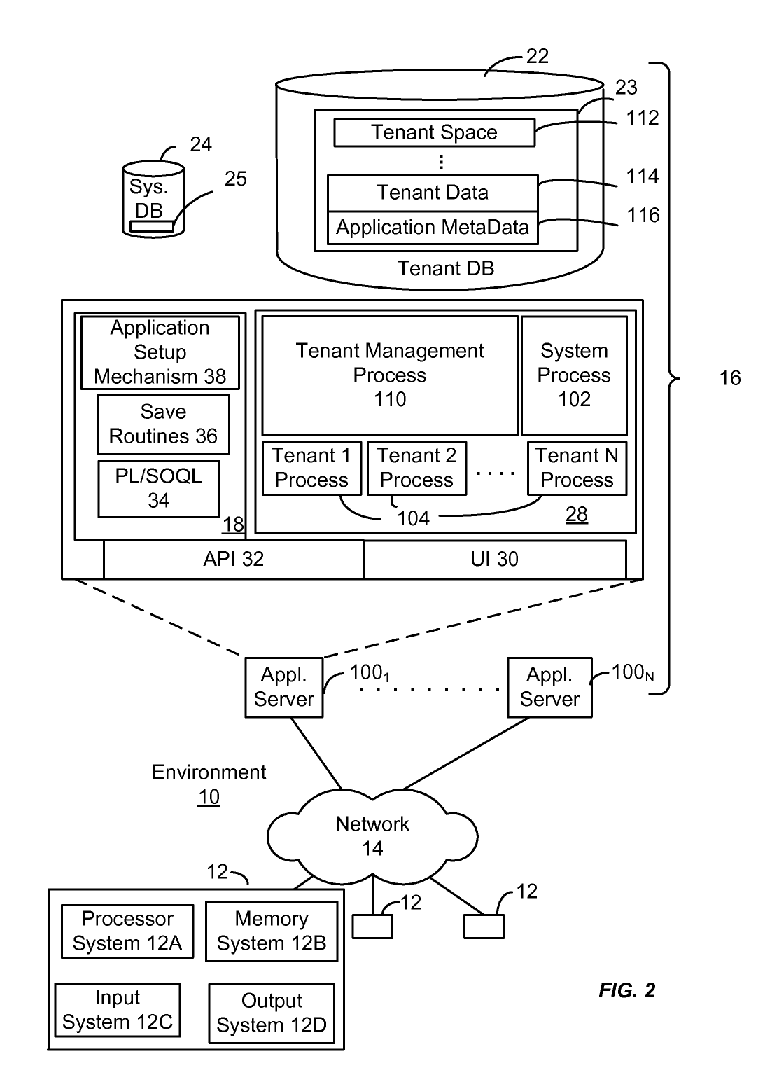

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, Programming Language Method and System for Extending APIs to Execute in Conjunction with Database APIs, by Craig Weissman, filed Oct. 4, 2006, which is incorporated in its entirety herein for all purposes. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. Yet another table or object might describe an Opportunity, including fields such as organization, period, forecast type, user, territory, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is incorporated herein by reference, teaches systems and methods for creating custom objects as well as customizing standard objects in a multi-tenant database system.

### Upgradeable Subscriber-Controlled Managed Package Components

According to an embodiment, a method can be used to allow for packaging of standard Action Overrides. Below is a brief description of the feature: Salesforce.com provides capabilities to override default standard actions for custom objects. Standard actions include a finite set of actions such as “List” and “Delete.” The effect of overriding a standard action “List” with a custom Visualforce page for example is that going to the “List” view of the custom object in the UI will take the user to the custom Visualforce page, as opposed to default Salesforce.com page. Previous systems enabled overriding standard actions for custom objects with custom Visualforce pages and Scontrols, but did not provide a way for managed package developers to package the overrides. Developers would include custom objects and Visualforce pages in the package for example, and then once a subscriber would install the package, the developer would work with the subscriber to create proper action overrides. The systems and methods described herein enable packaging of standard action overrides.

In a multi-tenant environment, specific component types get stored in a separate relational database table. A component type can be derived from the primary key of the table (e.g. component id). One of the columns is an organization identification (id), which determines the context in which the component is to be used. The table has an alternate key defined, so it's possible to identify a specific row by knowing a combination of column values that doesn't contain a primary key. In one embodiment, this alternate key is used to identify a component.

Previously, an example for a component table (prior to application of the method described) might look like:

----------------------------------------------------------------------
organization_id | component_id | value1 | value2 | etc.
----------------------------------------------------------------------
PK: component_id, AK: organization_id, value1, value2

Developer organizations for managed packages always have assigned namespaces, which uniquely identify developer organization. To accomplish upgradeable subscriber-controlled managed package components, in one embodiment a column is introduced to the component table that specifies the component namespace.

---------------------------------------------------------------------------------------
organization_id | component_id | namespace | value1 | value2 | etc.
---------------------------------------------------------------------------------------
PK: component_id, AK: organization_id, namespace, value1, value2

In effect, the alternate key is changed to include this namespace column as well. This allows for identification of all rows of interest in the component table that differ by namespace value. In one embodiment, the following logic is used to choose a component of interest:

1) If only developer namespace row exists, use that row
2) If a subscriber namespace row exists, use that row (note, if subscriber organization does not have a namespace, a row without namespace will be considered as subscriber-owned)
Case 1 can occur when subscriber has not developed a component of their own to override the component supplied by developer in a managed package. Case 2 can occur subscriber has created such component of their own.

In one embodiment, the above design is flexible when it comes to upgrades. When a subscriber installs a package upgrade, containing a new version of the component (in effect, a row with the same values for the alternate key column combination and updated values for other columns), only the row with developer namespace is updated. After this, in case 1 above, the new component will be used. In case 2, the subscriber component will continue to be used, but if the subscriber decides to stop using their own component and go back to using the one supplied by developer with the package, the new component will be used. This allows developers to make upgrades without being disruptive to subscribers, who in turn get to choose whether they want to continue using components of their own or use developer provided upgraded components.

The following table illustrates a scenario walkthrough that describes actions of the developer and subscriber and the database state in the subscriber organization.

| Scenario | | |
|---|---|---|
| Order | Action | NS CONTENT |
| 1 | Developer packages an | [ . . . dev_ns . . . VF/SC . . . ] |
| | action override in V1.0. | |
| | Subscriber installs V1.0. | |
| 2 | Subscriber adds own | [ . . . dev_ns . . . VF/SC . . . ] |
| | override. | [ . . . local_ns . . . VF/SC . . . ] |
| 3 | Developer deletes override | [ . . . local_ns . . . VF/SC . . . ] |
| | in v2.0 (using Default). | |
| | Subscriber upgrades to | |
| | V2.0. | |
| 4 | Developer adds new | [ . . . dev_ns . . . VF/SC . . . ] |
| | override to V3.0. | [ . . . local_ns . . . VF/SC . . . ] |
| | Subscriber upgrades to | |
| | V3.0. | |
| 5 | Subscriber moves to | [ . . . dev_ns . . . VF/SC . . . ] |
| | Default. | |
| 6 | Subscriber moves to | [ . . . dev_ns . . . VF/SC . . . ] |
| | Standard. | [ . . . local_ns . . . EMPTY KEY . . . ] |
| 7 | Developer deletes | [ . . . local_ns . . . EMPTY KEY . . . ] |
| | override in V4.0. | |
| | Subscriber upgrades to | |
| | V4.0. | |
| 8 | Developer adds new | [ . . . dev_ns . . . VF/SC . . . ] |
| | override to V5.0. | [ . . . local_ns . . . EMPTY KEY . . . ] |
| | Subscriber upgrades to | |
| | V5.0. | |

In some embodiments, a user can retrieve and deploy either visualforce or scontrol overrides through the API. In other embodiments, the package developer can delete overrides, which are subsequently deleted in the subscriber organization. In other embodiments, all changes made by the subscriber are sticky in the subscriber's organization. In other embodiments, all retrieve results are obfuscated (restricted to organization namespace). In other embodiments, an integrated development environment (IDE) retrieve returns an entry for each action (as a convenience). In other embodiments, an IDE retrieve returns only one override per action (as a convenience)

An action override type (enum) can include a Visualforce, Scontrol, Standard or Default type. Visualforce is an action override with Visualforce content. Scontrol is an action override with Scontrol content. Standard indicates that the action should use the standard host UI (such as a salesforce.com user interface). Default indicates that the action should use the developer override if it is present (and not deleted) or otherwise should use the standard host UI. A standard override can be saved just like an Scontrol or Visualforce override expect it's content will contain the empty key. In some embodiments, an action override will be a child entity of a custom object.

In some embodiments, the action override metadata includes the following tags: 1) actionName, content, comment, and type. ActionName is the Action name (e.g. New, Edit, etc). Content is the developer name of active content for this override (e.g. Visualforce page or Scontrol). Comment is the comments associated with this override. Type—is the action Override Type.

Retrieves can be used to gather action override rows on a per custom object per action basis. This can result in up to two rows per action (a developer row and a subscriber row). However, in some embodiments only one override per action will ever be shown in the xml. The following table provides examples of how action override type can be correlated to the database state.

| | |
|---|---|
| Visualforce (Tags shown: | An action override row exists with the org ns |
| All) | and visualforce content. |
| Scontrol (Tags shown: | An action override row exists with the org ns |
| All) | and scontrol content. |
| Standard (Tags shown: | An action override row exists with the org ns |
| actionName, | and empty key content. For example, |
| comments, type) | NS CONTENT |
| | [ . . . local_ns . . . EMPTY KEY . . . ] |
| Default (Tags shown: | Either no rows exist or only a developer row |
| actionName, type) | exists. For example, |
| | NS CONTENT |
| | <no rows exist> |
| | [ . . . local_ns . . . EMPTY KEY . . . ] |
| | [ . . . dev_ns . . . VF/SC . . . ] |

Each action override type can be deployed. Visualforce is deployed by upserting a visualforce action override. Scontrol can be deployed by upserting a scontrol action override. Standard can be deployed by upserting a row with empty key content. Default can be deployed by deleting any action override row by namespace. Upserting is defined to mean uploading and inserting.

UI Changes can be made in three places in the UI: the Action Override Related List, the Action Override Detail Page and the Action Override Edit Page. Changes that can be made to the Action Override Related List include 1) rename the Override action to Edit, 2) drop the Reset action (this functionality will be moved to the edit page), 3) indicate in the Overridden check box that a local (non deleted) action override exists, 4) rename the Content Name column to Display; and 5) show, in the Display column, the local action override (if it exists) or the default action override. Changes that can be made to the Action Override Detail Page include 1) remove Reset button, 2) add Overridden check box, and 3) combine Content Name and Content Type fields into Display field (like Display column on the related list). Changes that can be made to the Action Override Edit Page include 1) add the Default field which will show the default action override (defined as the installed action override if it exists or the standard host UI), and 2) replace the Content Type and Content Name fields with an Override With field. The Override With field can include all possible action override types (see function spec). The Override With field can have a Default, Scontrol and Visualforce option. A standard option will be added if the default override is an installed override (as opposed to the standard host UI which appears if an installed override is not available). The save actions on the various types can correspond to the deploy actions detailed above.

In one embodiment, another way of choosing what component to use is accomplished by adding an “IS_ACTIVE” column, which would hold the boolean meaning whether or not a particular component row should be used for a given alternate key combination. One advantage of this is that it allows for maintaining components from more than just a single developer organization and subscriber organization—it's technically possible to have components for an unlimited number of organizations, as long as they can be uniquely identified by namespace.

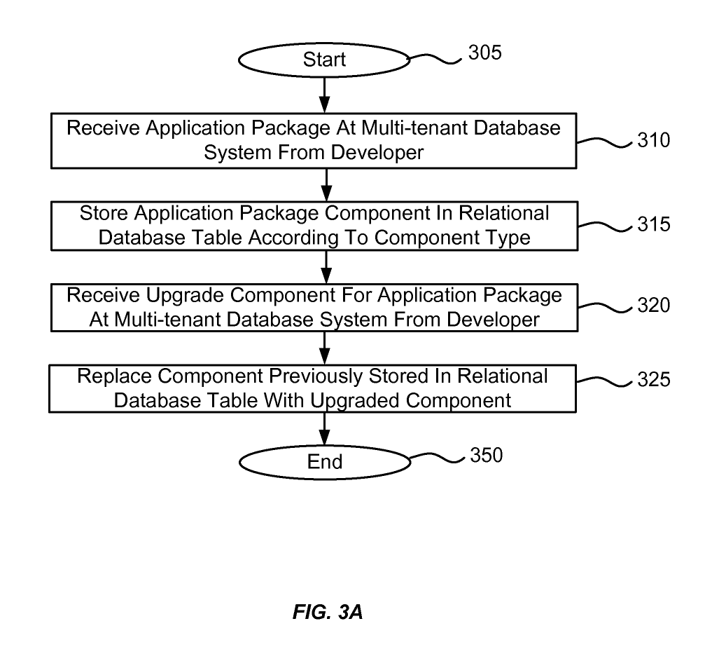

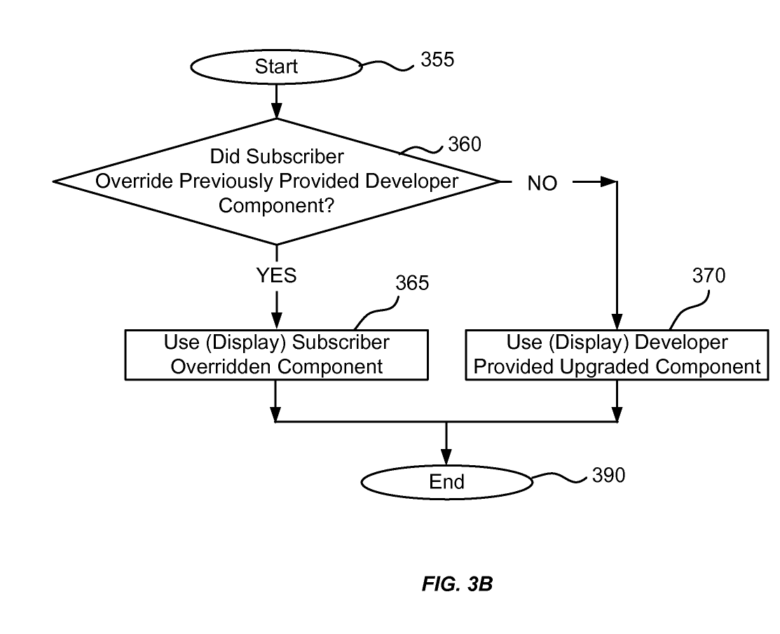

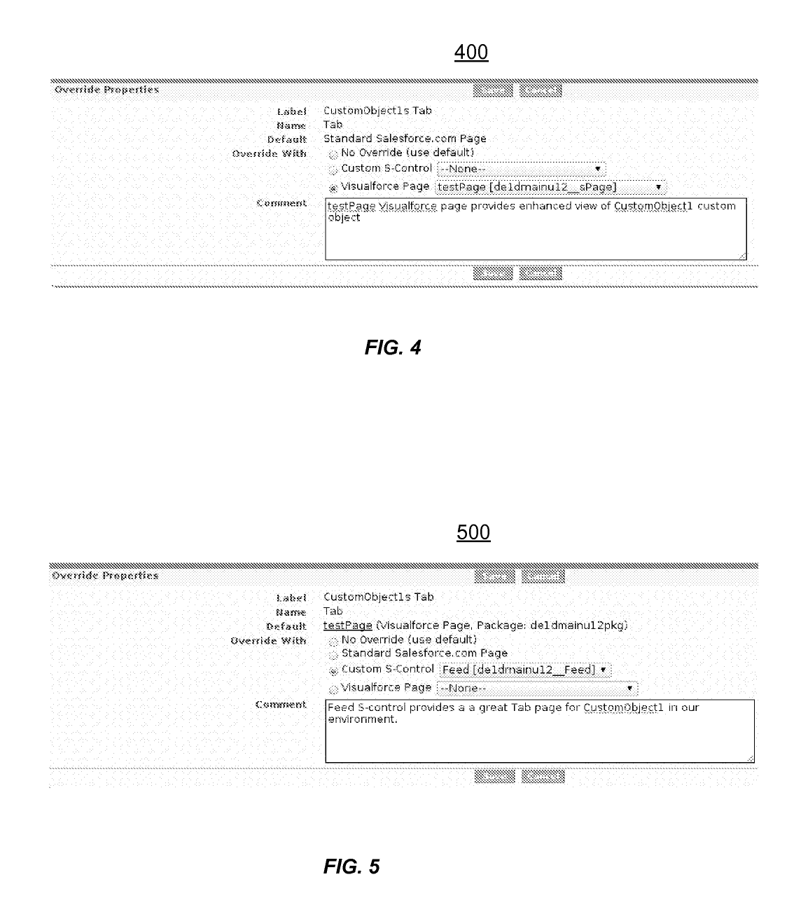

FIG. 3A is a flowchart illustrating a method of upgrading application packages installed in a multi-tenant database system as represented in FIGS. 4-15. The method starts in operation 305 when the multi-tenant database system is configured for operation. In operation 310, the multi-tenant database system receives an application package from a developer. As part of this operation, the application package is also saved or stored in at least one of the databases in the multi-tenant database system. The application package includes at least one developer provided (original) component that is upgradeable by the developer and is provided as part of the developer's package for subscribers to install and use. Next in operation 315, the at least one developer provided component which is received from the developer is stored in a relational database table according to component type. If a subscriber has requested access to the application package, the components of the application package can also be stored in a second location of the database.

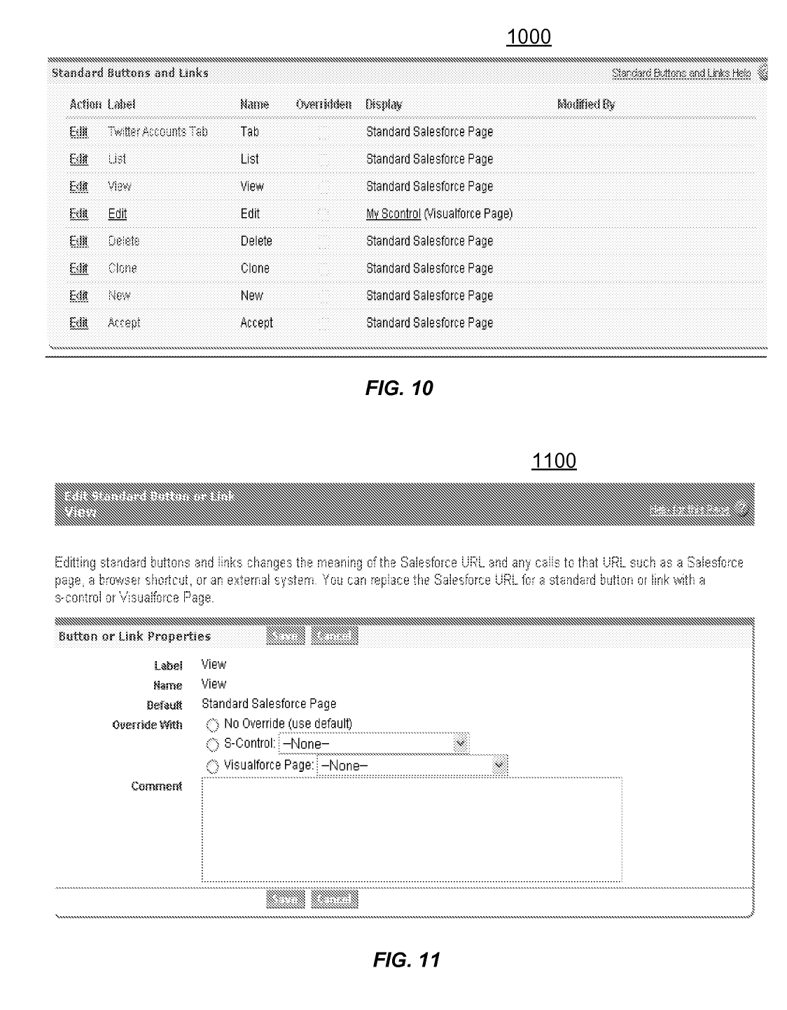

Once the application package is stored in the database, the subscriber can use (i.e. enable) or override some of the application package components provided by the developer with other components that can be generated by the subscriber or another third party, as discussed with reference to FIGS. 10-15. The components provided by the developer can be original components or upgraded components provided by the developer. Override can include completely changing a developer provided component or modifying a portion of the developer provided component so the developer provided component is no longer the same as it was provided by the developer. In one embodiment, if the subscriber overrides any of the developer provided components with non-developer provided second components and/or uses second component instead of the components supplied by the developer, then a subscriber row is stored in a table. The subscriber row includes an indicator indicating that the subscriber has either overridden the developer provided component or is using (i.e. enabled) an alternate component instead of the developer provided component. In this embodiment, if the subscriber is using the developer provided component, without overriding the developer provided component, then a subscriber row is not stored in the table.

In operation 320, the multi-tenant database system receives an upgraded component of the application package from a developer. The upgraded component can be any part of the application package to which the developer has made changes. The upgrades can be to components which can only be modified by the developer, components which are needed to run the application package, or components which are optional or can be overridden by a subscriber. In one embodiment, if the developer provides an upgraded component to be used by the subscribers, then a developer row is stored in the same table where the subscriber row was stored. The developer row also includes an indicator indicating that the developer has uploaded and made available an upgraded component that is ready for use by the subscribers. Next in operation 325, the at least one component stored in the relational database is replaced with an upgraded component received in operation 320. If a subscriber has requested access to the application package, the at least one component stored in a second location of the database is also replaced with the upgraded component received in operation 320. After the upgraded application package provided by the developer is installed in the multi-tenant database system the process ends in operation 350. During the runtime a determination is made regarding whether to use the upgraded developer components or use other components that have been modified by the subscriber, as explained with reference to FIG. 3B below.

FIG. 3B is a flowchart illustrating how to determine which component (subscriber's variation or developer's variation) to use at the runtime of the application, according to one embodiment. As explained above with reference to FIG. 3A, a developer provides an original component which is later upgraded by the developer to an upgraded component. During this upgrade, the subscriber's instance of the application is also upgraded so that original component provided by the developer is changed to the upgraded component provided by the developer. However, in some instances the subscriber will have overridden aspects of the original component with their own settings before the developer upgrades the original component with an upgraded component. In one embodiment, the subscriber's instance of the application will store both the subscriber's variation of the component (i.e. the overridden component) and the upgraded component provided by the developer. At runtime, in some embodiments the subscriber's variation is used as long as it exists, even though a developer provided upgraded component has been made available. Therefore, at runtime a decision is made whether to use the subscriber's variation of the component (i.e. the overridden component) or the developer provided upgraded component.

If the developer provided upgraded component is needed by the application package or if the subscriber has not been given the option to modify the component, then the developer provided upgraded component is set to be used by the subscriber. However, if the component is not essential to the application program or if the subscriber has the option of overriding the component then the developer provided upgraded component may or may not be used by the subscriber even though the developer provided upgraded component was loaded onto the subscriber. The process of determining which component (subscriber's variation or developer's variation) to use at the runtime of the application starts in operation 355 when the subscribers instance of the application starts running. In operation 360, a decision is made whether the previously provided developer component, in operation 310 of FIG. 3A, has been overridden by the subscriber. This decision can be made by determining whether the previously provided developer component, which can now be upgraded, is being used or has been enabled at the subscriber. In one embodiment, the determination of whether the previously provided developer component is being used by the subscriber is made by examining the developer and subscriber rows stored in the table. If the subscriber row has not been saved in the table, then the previously provided developer component is being used at the subscriber without overriding it. On the other hand, if the subscriber row has been saved in the table, then the previously provided developer component has not been used at the subscriber without overriding it.

If the decision in operation 360 is that the subscriber did override the previously provided developer component, then in operation 365 the subscriber's variation of the component (i.e. the overridden component) is used. In one embodiment, using the subscriber overridden component begins by displaying the subscriber overridden component to the subscriber. In this case, the subscriber continues to use his existing previously provided component, which does not include developer upgrades but does include any overrides or changes that the subscriber has made. This is advantages to the subscriber because the subscriber does not have to make changes to a developer provided upgraded component to incorporate his preferences which would have been lost if the developer provided upgraded component had been used instead. If the decision in operation 360 is that the subscriber did not override the previously provided developer component, then in operation 370 the developer provided upgraded component is used. In one embodiment, using the developer provided upgraded component begins by displaying the developer provided upgraded component to the subscriber. This change should be transparent to the subscriber because the change will only change use of components that have not been altered by the subscriber. If the decision in operation 360 is that the subscriber did not override the previously provided developer component, and therefore, use the developer provided upgraded component, then in one embodiment the developer provided upgraded component is set up for use instead of the previously provided developer component automatically, without informing the user. In another embodiment, the multi-tenant database system can ask the subscriber for permission before setting up the developer provided upgraded component. In either case, the developer provided upgraded component is setup for use by the subscriber instead of the previously provided developer component. The process ends in operation 390 after the decision is made and the subscriber's instance of the application continues to run.

In some embodiments, the subscriber can always opt to delete their variation of the component (i.e. the overridden component). If the subscriber's variation of the component is deleted, then the subscriber's instance of the application reverts to using the latest version of the developer provided component, which would be developer provided upgraded component, if it exists. So if the subscriber deletes their variation of the component, then the developer's variation is used as it appears in the last upgraded version since this subscriber's instance of the application has already been upgraded. In some embodiments, the subscriber cannot pick between using the previously provided developer component and the developer provided upgraded component. The subscriber's instance of the application uses whatever version of the application is running which would include the latest upgrades.

Since at least one (developer controlled) row for each component is maintained, if an upgrade to the developer software is performed, the contents of the associated developer row is replaced. The developer software including components is saved or stored in at least one of the databases in the multi-tenant database system. If a subscriber overrides a previously provided component at the subscriber, another row, which is a subscriber controlled row, is generated. In an embodiment, the subscriber row is not changed or modified when there is an upgrade. Therefore, if there are upgrades to the components saved in the databases in the multi-tenant database system, only the developer row is modified but not the subscriber row.

FIG. 4 illustrates a user interface (UI) page 400 in the developer organization according to one embodiment. In this instance, developer chooses to override Tab standard action on CustomObject1 custom object with the Visualforce page testPage. Note, other alternatives for developer include overriding Tab action with a different Visualforce page, with an Scontrol, or not overriding the action at all by choosing standard Salesforce.com page. We are assuming that developer includes CustomObject1 and testPage into a managed package and exports the package, making it available to subscribers.

FIG. 5 illustrates a UI page 500 in the subscriber organization according to one embodiment. It is assumed that the subscriber has installed the managed package from the developer organization mentioned with regard to FIG. 4. In this instance, the subscriber chooses to override developer provided action with Feed Scontrol. Other alternatives for the subscriber include relying on the default override supplied by the developer, overriding the Tab with a different Scontrol or a Visualforce page, or relying on standard actions provided by the host, e.g., Salesforce.com. In one aspect, if the developer were to override the action Tab with testPage2, the subscriber will be able to use this developer provided override regardless of what option they choose in FIG. 5.

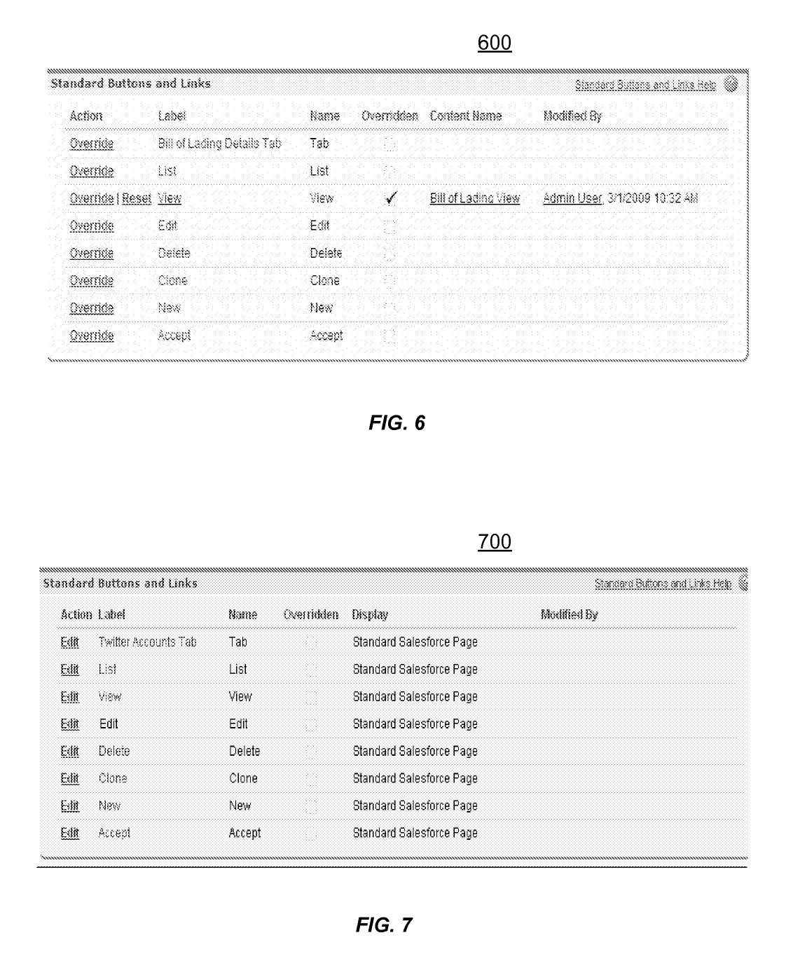

FIG. 6 illustrates a UI page 600 in the multi-tenant database system according to one embodiment. The page 600 includes columns labeled Action, Label, Name, Overridden, Content Name and Modified By. The Action column displays the action that can be performed on the Label/Name. The actions that are possible are to override the settings in the individual

Label/Name or to reset the settings that have previously been overridden as is shown for the “View” Label/Name. The Overridden column indicates when Label/Name has been overridden. In this example, the “View” has been overridden and the content name has been changed to “Bill of Laden View.” The person who made the changes is identified as well as the time and date that the changes were made.

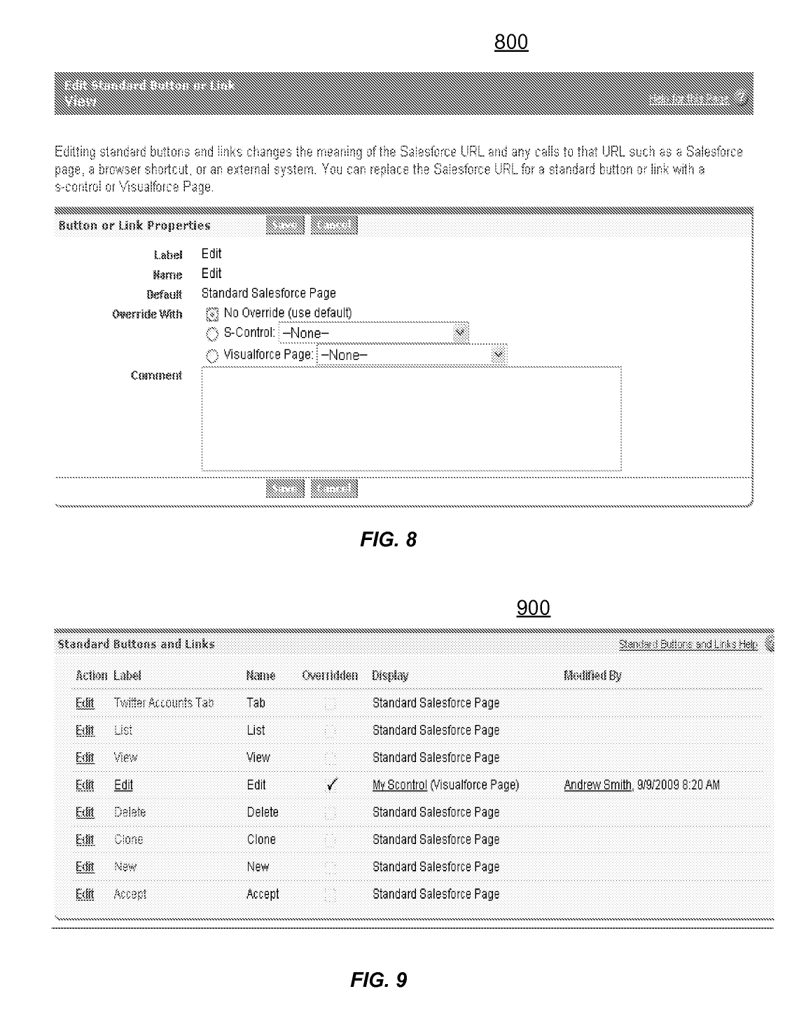

FIG. 7 illustrates a page 700, which corresponds to page 600 illustrated in FIG. 6, as it appears in the developer organization according to one embodiment. The page 700 includes columns labeled Action, Label, Name, Overridden, Display and Modified By. The Action column displays the action that can be performed on the Label/Name by the developer. The Overridden column indicates when Label/Name has been overridden by a developer so that the default settings provided by the multi-tenant database system are no longer in effect. The developer can override any of the Labels by selecting the Edit action. When an Edit action is selected by the developer, a new page, as illustrated in FIG. 8, opens which allows the developer to edit the contents of the Label associated with the Action selected.

FIG. 8 illustrates the page 800 that opens when the developer selects an Edit action illustrated in page 700 for the Label/Name identified as “Edit,” according to one embodiment. The page 800 is an edit standard button or link view, in accordance to one embodiment. Page 800 is shown as it appears in the developer organization. The developer can change Edit action properties selecting the No Override, Scontrol, or Visualforce Page. If the No Override setting is selected, then the defaults provided by the multi-tenant database system are used. If the Scontrol setting is selected, the developer can select between at least one Scontrol in the drop down box next to the Scontrol setting. If the Visualforce Page setting is selected, the developer can select between at least one Visualforce Page in the drop down box next to the Visualforce Page setting. The developer can also enter comments in the comments section. By selecting the Scontrol or Visualforce Page setting, the developer will override the default settings provided by the multi-tenant database system, so that when the developer deploys the package being developed, the overridden settings will appear to the subscriber who installs it. After the developer is done with editing an action, a new page, as illustrated in FIG. 9, opens indicating which action has been overridden.

FIG. 9 illustrates page 900 after the developer has overridden the “Edit” action, as it appears in the developer organization, according to one embodiment. Page 900 can be a refreshed or updated Page 700 showing the overridden status of the Label/Name after an action has been updated. Page 900 is similar to page 700 except that the overridden box for the “Edit” Label/Name is checked, the display has been changed from “Standard Salesforce Page” to “My Scontrol (Visualforce Page),” and the Modified By column identifies who and when did the overriding.

After the developer finishes developing the package, the developer loads the package onto the multi-tenant database system so that subscribers can install the package if desired. After a subscriber uploads and installs a developer's package, page 1000, as illustrated in FIG. 10, is displayed to the subscriber's organization. Page 1000 corresponds to page 900 and is similar to page 900 except that the overridden box for the “Edit” Label/Name is not checked and the Modified By column is empty.

As with the developer organization, the subscriber organization can also edit an item having a Name or Label. FIG. 11 illustrates the page 1100 that opens when the subscriber selects an Edit action illustrated in page 900 for the Label/Name identified as “View,” according to one embodiment. Page 1100 is shown as it appears in the subscriber organization and can be similar to page 800 except that the subscriber organization can perform the edits to the action instead of the developer organization. In some embodiments, page 1100 is similar to page 800 whereas in other embodiments, page 1100 is different than page 800. Page 1100 is an edit standard button or link view, in accordance to one embodiment. The subscriber can change “View” action by selecting the No Override, Scontrol, or Visualforce Page. If the No Override setting is selected, then the defaults provided by the multi-tenant database system are used. If the Scontrol setting is selected, the subscriber organization can select between at least one Scontrol in the drop down box next to the Scontrol setting. If the Visualforce Page setting is selected, the subscriber organization can select between at least one Visualforce Page in the drop down box next to the Visualforce Page setting. The subscriber organization can also enter comments in the comments section. By selecting the Scontrol or Visualforce Page setting, the subscriber organization will override the default settings provided by the multi-tenant database system, so that when the subscriber organization can use the package deployed by the developer organization but with his customized features.

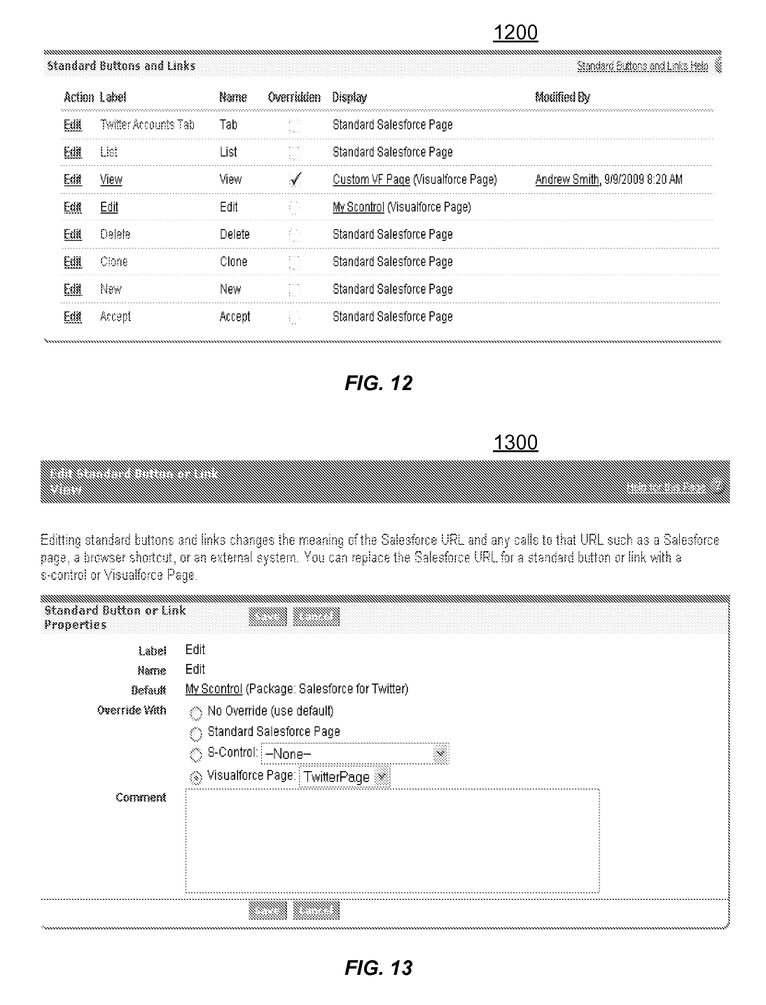

FIG. 12 illustrates page 1200 after the subscriber organization has overridden the “View” Label/Name, according to one embodiment. Page 1200 is shown as it appears in the subscriber organization. Page 1200 can be a refreshed or updated Page 1000 showing the overridden status of the Label/Name after an action has been updated. Page 1200 is similar to page 1000 except that the overridden box for the “View” Label/Name is checked, the display has been changed from “Standard Salesforce Page” to “Custom VF Page (Visualforce Page),” and the Modified By column identifies who did the overriding and when the overriding was done.

The subscriber can also opt to override the “Edit” action supplied by the developer. If the subscriber organization selects the Edit action illustrated in pages 1000 or 1100 for the Label/Name identified as “Edit,” then page 1300 illustrated in FIG. 13 is displayed, according to one embodiment. Page 1300 is shown as it appears in the subscriber organization and can be similar to page 1100 except that there is an overriding option to select the standard multi-tenant database system default setting. Page 1300 is an edit standard button or link view, in accordance to one embodiment. The subscriber can change the “Edit” action by selecting the No Override, Standard Salesforce Page, Scontrol, or Visualforce Page. If the No Override setting is selected, then the defaults provided by the developer organization are used. If the Standard Salesforce Page setting is selected, then the defaults provided by the multi tenant database system are used. In this example, the multi tenant database system is the system provided by Salesforce. If the Scontrol setting is selected, the subscriber organization can select between at least one Scontrol in the drop down box next to the Scontrol setting. If the Visualforce Page setting is selected, the subscriber organization can select between at least one Visualforce Page in the drop down box next to the Visualforce Page setting.

In this example, the subscriber organization has selected the Visualforce Page setting and has selected the TwitterPage from the drop down box next to the Visualforce Page setting. By selecting the Visualforce Page setting and the TwitterPage from the drop down box, the subscriber organization will override the settings selected by the developer organization. In this example, the subscriber organization overrides the settings for the “Edit” Label/Name from “My Scontrol (Visualforce Page),” which was previously set by the developer organization, to the Visualforce Page setting with the TwitterPage. The subscriber organization has now changed the settings of the “Edit” Label/Name to be different from both the default settings provided by the multi tenant database system and the settings provided by the developer organization.

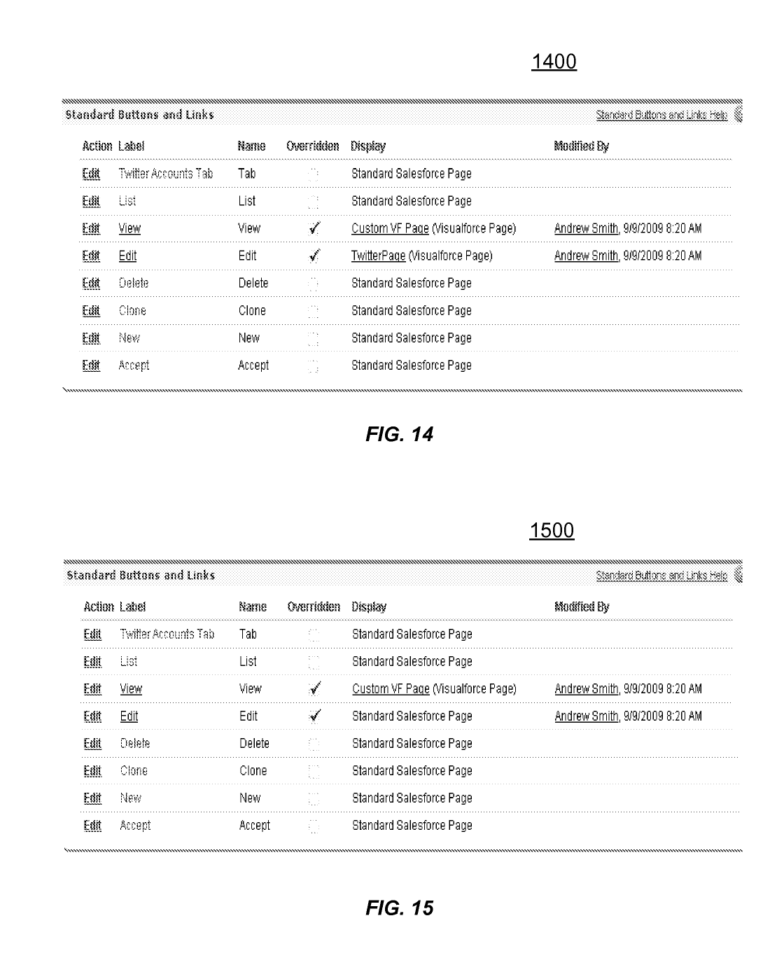

FIG. 14 illustrates page 1400, as it appears in the subscriber organization, after the subscriber organization has overridden the “Edit” Label/Name, according to one embodiment. Page 1400 can be a refreshed or updated Page 1200 showing the overridden status of the Label/Name after an action has been updated. Page 1400 is similar to page 1200 except that the overridden box for the “Edit” Label/Name is checked, the display has been changed from “My Scontrol (Visualforce Page),” which was previously set by the developer organization, to “TwitterPage (Visualforce Page),” and the Modified By column identifies who did the overriding and when the overriding was done.

FIG. 15 illustrates page 1500 after the subscriber organization has overridden the “Edit” Label/Name settings from “My Scontrol (Visualforce Page),” which was previously set by the developer organization, to the “Standard Salesforce Page” setting, according to one embodiment. Page 1500 is shown as it appears in the subscriber organization. Page 1500 can be a refreshed or updated Page 1200 showing the overridden status of the Label/Name after an action has been updated. Page 1500 is similar to page 1200 except that: 1) the overridden box for the “Edit” Label/Name is checked, 2) the display has been changed from “My Scontrol (Visualforce Page),” which was previously set by the developer organization, to the “Standard Salesforce Page” setting, and 3) the Modified By column identifies who did the overriding and when the overriding was done. In this example, the overridden box for the “Edit” Label/Name is checked to indicate that the setting provided by the developer organization has been changed.

Although specific embodiments of the invention have been described, various modifications, alterations, alternative constructions, and equivalents are also encompassed within the scope of the invention. The described invention is not restricted to operation within certain specific embodiments, but is free to operate within other embodiments configurations as it should be apparent to those skilled in the art that the scope of the present invention is not limited to the described series of transactions and steps.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claim.

What is claimed is:

1. A method for upgrading application packages installed in a multi-tenant database system, comprising:
receiving an application package from a developer, the application package comprising at least one first component that is upgradeable by the developer;
storing the at least one first component in a relational database table according to component type;
receiving an upgraded first component from the developer;
replacing the at least one first component stored in the relational database with an upgraded first component;
upon determining that the at least one first component is being used by a subscriber and not overridden with a second component, using the upgraded first component instead of the at least one first component.

2. The method of claim 1 wherein the second component that overrides the at least one first component is generated by the subscriber.

3. The method of claim 1 further comprising:
storing a developer row in a table, wherein the developer row comprises a first indicator indicating that the at least one first component has been upgraded; and
upon determining that the at least one first component has been overridden with the second component, storing a subscriber row in the table, wherein the subscriber row comprises a second indicator indicating that the subscriber is using the second component.

4. The method of claim 3 further comprising determining that the at least one first component is being used by the subscriber and not overridden if the subscriber row has not been stored in the table.

5. The method of claim 3 further comprising:
determining that the at least one first component is not used if the subscriber row has been stored in the table; and
upon determining that the at least one first component is not being used, continuing to use the second component instead of the upgraded first component.

6. The method of claim 1 wherein using the upgraded first component instead of the at least one first component comprises automatically using the upgraded first component.

7. A method comprising:
storing an application package from a developer, the application package comprising at least one first component that is upgradeable by the developer;
generating multiple versions of the at least one first component;
storing information about the multiple versions of the at least one first component, each version having a different ownership;
receiving an upgraded first component from the developer;
manipulating the information about the multiple versions of the same stored managed component based on whether the at least one first component is being used by a subscriber and not overridden with a second component;
wherein the storing and manipulating is done in the context of the subscriber organization.

8. The method of claim 7 wherein:
storing information further comprises storing a developer row in a table, wherein the developer row comprises a first indicator indicating that the at least one first component has been upgraded; and
manipulating the information further comprises storing a subscriber row in the table if the subscriber is using the second component instead of the at least one first component, wherein the subscriber row comprises a second indicator indicating that the subscriber is using the second component.

9. The method of claim 8 further comprising determining that the at least one first component is being used and not overridden if the subscriber row has not been stored in the table.

10. The method of claim 8 further comprising:
determining that the at least one first component is not being used if the subscriber row has been stored in the table; and
upon determining that the at least one first component is not being used, continuing to use the second component instead of the upgraded first component.

11. The method of claim 7 further comprising:
upon determining that the at least one first component is being used and not overridden, using the upgraded first component instead of the at least one first component.

12. The method of claim 11 wherein using the upgraded first component instead of the at least one first component comprises automatically using the upgraded first component.

13. A computer-readable medium storing computer code for controlling one or more processor components to manage upgrading application packages installed in a multi-tenant database system, the code comprising instructions to:
receive an application package from a developer, the application package comprising at least one first component that is upgradeable by the developer;
store the at least one first component in a relational database table according to component type;
receive an upgraded first component from the developer;
replace the at least one first component stored in the relational database with an upgraded first component;
upon determining that the at least one first component is being used by a subscriber and not overridden with a second component, use the upgraded first component instead of the at least one first component.

14. The computer-readable medium of claim 13 wherein the second component that overrides the at least one first component is generated by the subscriber.

15. The computer-readable medium of claim 13 wherein the code further comprises instructions to:
store a developer row in a table, wherein the developer row comprises a first indicator indicating that the at least one first component has been upgraded; and
upon determining that the at least one first component has been overridden with the second component, store a subscriber row in the table, wherein the subscriber row comprises a second indicator indicating that the subscriber is using the second component.

16. The computer-readable medium of claim 15 wherein the code further comprises instructions to determine that the at least one first component is being used and not overridden if the subscriber row has not been stored in the table.

17. The computer-readable medium of claim 15 wherein the code further comprises instructions to:
determine that the at least one first component is not being used if the subscriber row has been stored in the table; and
upon determining that the at least one first component is not being used, continue to use the second component instead of the upgraded first component.

18. The computer-readable medium of claim 13 wherein the instructions to use the upgraded first component instead of the at least one first component comprises instructions to automatically use the upgraded first component.

19. A computer-readable medium storing computer code for controlling one or more processor components to manage upgrading application packages installed in a multi-tenant database system, the code comprising instructions to:
store an application package from a developer, the application package comprising at least one first component that is upgradeable by the developer;
generate multiple versions of the at least one first component;
store information about the multiple versions of the at least one first component, each version having a different ownership;
receive an upgraded first component from the developer;
manipulate the information about the multiple versions of the same stored managed component based on whether the at least one first component is being used by a subscriber and not overridden with a second component;
wherein the instructions to store and manipulate is done in the context of the subscriber organization.

20. The computer-readable medium of claim 19 wherein:
store information further comprises instructions to store a developer row in a table, wherein the developer row comprises a first indicator indicating that the at least one first component has been upgraded; and
manipulate the information further comprises instructions to store a subscriber row in the table if the subscriber uses a second component instead of the at least one first component, the subscriber row comprising a second indicator indicating that the subscriber is using the second component.

21. The computer-readable medium of claim 20 wherein the code further comprises instructions to determine that the at least one first component is being used and not overridden if the subscriber row has not been stored in the table.

22. The computer-readable medium of claim 20 wherein the code further comprises instructions to:
determine that the at least one first component is not being used if the subscriber row has been stored in the table; and
upon determining that the at least one first component is not being used, continue to use the second component instead of the upgraded first component.

23. The computer-readable medium of claim 19 wherein the code further comprises instructions to:
upon determining that the at least one first component is being used and not overridden, use the upgraded first component instead of the at least one first component.

24. The computer-readable medium of claim 23 wherein the instructions to use the upgraded first component instead of the at least one first component comprises instructions to automatically use the upgraded first component.

25. A system for managing installation and upgrades of application packages installed to a multi-tenant database system; the system comprising:
a database system for storing at least one first component of the application package according to component type; and
one or more processors configured to:
receive the application package from a developer that has at least one first component that is upgradeable by the developer;
store the at least one first component in the database table according to component type;
responsive to receiving from the developer an upgraded first component, replace the at least one first component stored in the relational database with the upgraded first component;
upon determining that the at least one first component is being used by a subscriber and not overridden with a second component, use the upgraded first component instead of the at least one first component.
